(19) United States
(12) Patent Application Publication
(10) Pub. No.: US 2019/0351994 A1
(43) Pub. Date: Nov. 21, 2019

(54) Retractable aircraft control surface

(71) Applicant: Richard Michael Truhill, Plano, TX (US)

(72) Inventor: Richard Michael Truhill, Plano, TX (US)

(21) Appl. No.: 15/932,881

(22) Filed: May 16, 2018

(51) Int. Cl. B64C 5/12; B64C 5/02; B64C 9/36

(52) U.S. Cl. CPC B64C 5/12; B64C 9/36; B64C 5/02

(57) ABSTRACT

A modification to conventional aircraft empennage design, which is also adaptable to all-wing aircraft. Vertical stabilizer/rudder assemblies are hinged such that actuator and lock mechanisms are able to vary the aircraft empennage configuration from one with fully functional conventional vertical stabilizer(s)/rudder(s) to one with no vertical stabilizer/rudder.

### BACKGROUND OF THE INVENTION

### 1. Field of the Invention

The invention relates to aircraft empennage design, applicable to conventional aircraft design with a horizontal stabilizer and one or more vertical stabilizer/rudder assemblies, as well as all-wing aircraft design. The invention would allow an aircraft with one or more conventional vertical stabilizer/rudder assemblies to retract the stabilizer/rudder assemblies in flight from vertical to horizontal, creating less drag, thereby increasing speed, while also improving stealth characteristics. Conversely, the invention would allow an aircraft to extend the stabilizer/rudder assemblies in flight from horizontal to vertical, providing increased control and maneuverability of the aircraft. For example, the invention would allow an all-wing aircraft, which dues not have a vertical stabilizer, to fold one or more sections of the aircraft into a position from horizontal to vertical, or to any desired angle, thereby improving its handling characteristics during takeoff and landing, and also improving maneuvering and high-performance capabilities. The vertical stabilizer/rudder assemblies described herein may have variable geometry, and vertical stabilizer/rudder assemblies may be hinged about different axes depending on the aircraft design.

### 2. Prior Art

U.S. Pat. No. 4,247,062 discloses a hinged vertical tail unit which allows variable wing geometry on an all-wing aircraft, specifically a glider returning from a space mission. The hinged vertical tail unit allows the pilot to better control the aircraft at large angles of attack. The hinged vertical tail units consist of the left and right outer sections of the wing itself.

U.S. Pat. No. 4,354,646 discloses an empennage assembly of a supersonic aircraft, which includes two tail control surfaces pivotally attached at the aft end of an aircraft fuselage substantially along the longitudinal axis, and which are designated “ruddervators” since their effect could be to act as a rudder, elevator, or combination of the two.

Conventional vertical stabilizers are usually part of the aircraft's structure and are referred to as the “tail section” or “empennage”. The vertical stabilizer/rudder provides control of the aircraft around the yaw axis, and it helps control the aircraft during takeoff and landing; coordinate turns; and maintain directional control during single engine operation for multiengine aircraft. However, it also creates drag during straight and level flight. For stealth aircraft, the presence of a vertical stabilizer/rudder is a great disadvantage. Therefore, it would be highly desirable to have aircraft which could be configured with vertical stabilizers/rudders in those situations where they are advantageous, but also have the capability to be configured without vertical stabilizers/rudders in those situations where they are undesirable.

### SUMMARY OF THE INVENTION

According to one embodiment of the invention, provided herein is a vertical stabilizer and rudder assembly wherein the assembly may be rotated about an axis extending substantially in parallel to the longitudinal axis of the aircraft. When retracted the assembly lies approximately parallel to the lateral axis of the aircraft, and when fully extended the assembly forms an angle greater than zero degrees above or below the lateral axis of the aircraft. Another embodiment of the invention provides a vertical stabilizer and rudder assembly wherein the assembly may be rotated about an axis extending substantially in parallel to the lateral axis of the aircraft. In this configuration, the assembly may be retracted into the body of the aircraft. The assembly could be either a one-piece integral stabilizer and rudder or a stabilizer with a separate rudder section attached by means of a hinge.

When extended, the vertical stabilizer/rudder assembly is of sufficient size to fulfill any operational requirements regarding stability or control of the aircraft about the yaw axis, thereby greatly improving the pilot's ability to fly the aircraft. When retracted, the aerodynamic drag produced by the intrusion of the assembly into the airstream is eliminated, enhancing the high speed performance characteristics of the aircraft. When retracted, the radar cross-section of the aircraft is greatly reduced, enhancing the stealth characteristics of the aircraft. The vertical stabilizer/rudder assembly of the present invention may be dimensioned as needed to provide sufficient size and shape to meet performance specifications. Some situations may not require all or nothing performance versus speed/stealth; or, for example, the pilot may prefer to utilize the assembly to provide more pitch control than yaw control; therefore, the assembly could be constructed as a combination vertical stabilizer/rudder and horizontal stabilizer/elevator (“ruddervator”), having the capability of being locked at any operational angle during flight.

Due to the above features, the invention provides yaw axis control and longitudinal directional stability when needed, while also providing high speed and/or stealth performance when needed. A drive means, such as an actuator mechanism, allows the pilot to change the aircraft configuration as needed in flight. A pivotal connecting means, such as a hinge mechanism, allows the assembly to move freely and smoothly. A latching means, such as a locking mechanism, allows the assembly to be secured in whatever configuration is desired by the pilot at any time. Thus it is possible to change the aircraft configuration to optimally meet the prevailing flight requirements in real time. Other geometric parameters could also be incorporated into the design very easily and provide an even greater level of performance.

Based on the conditions described above, the aim of the invention is to achieve the following objectives either singly or in combination:

to provide a retractable vertical stabilizer and rudder assembly for conventional aircraft whereby the assemble can be folded or stored such that the aerodynamic drag of the aircraft is decreased;
to provide a retractable vertical stabilizer and rudder assembly for conventional aircraft whereby the assemble can be folded or stored such that the stealth characteristics of the aircraft are increased;
to provide a retractable vertical stabilizer and rudder assembly for all-wing aircraft whereby the aircraft configuration can be modified to improve handling characteristics;
to provide a retractable vertical stabilizer and rudder assembly for stealth aircraft whereby the aircraft configuration can be modified to improve handling characteristics;
to arrange the retractable vertical stabilizer and rudder assembly in such a manner that does not interfere with any other aircraft components;
to provide a retractable vertical stabilizer and rudder assembly which can be quickly changed from one configuration to another;
to provide a retractable vertical stabilizer and rudder assembly which can be easily adjusted at various angles about an axis essentially parallel to the aircraft longitudinal axis;
to provide a retractable vertical stabilizer and rudder assembly which can be easily adjusted at various angles about an axis essentially parallel to the aircraft lateral axis.

### BRIEF DESCRIPTION OF THE DRAWINGS

Aspects of the present disclosure are best understood from the following detailed description when read with the accompanying figures. It is noted that in accordance with the standard practice in the industry various features are not drawn to scale. In fact, the dimensions of the various features may be arbitrarily increased or reduced for clarity of discussion.

FIG. 1 illustrates the various axes of an aircraft.

FIG. 2 illustrates the components of a retractable vertical stabilizer/rudder unit.

FIG. 3A illustrates a top plan view of a conventional aircraft configured with a retractable vertical stabilizer/rudder unit extended;

FIG. 3B illustrates a rear plan view of a conventional aircraft configured with a retractable vertical stabilizer/rudder unit extended;

FIG. 3C illustrates a top plan view of a conventional aircraft configured with a retractable vertical stabilizer/rudder unit retracted;

FIG. 3D illustrates a rear plan view of a conventional aircraft configured with a retractable vertical stabilizer/rudder unit retracted;

FIG. 4A illustrates a top plan view of an all-wing aircraft configured with a retractable vertical stabilizer/rudder unit retracted;

FIG. 4B illustrates a rear perspective view of an all-wing aircraft configured with a retractable vertical stabilizer/rudder unit extended;

FIG. 5A illustrates a top plan view of a retractable stabilizer/rudder unit configured to serve as a butterfly or v-tail (ruddervator) system retracted;

FIG. 5B illustrates a rear perspective view of a butterfly or v-tail system with the stabilizer/control assembly extended wherein the assembly is configured to serve as both vertical stabilizer and horizontal stabilizer, as well as both rudder and elevator.

FIG. 6A illustrates a top plan view of a high speed aircraft configured with a retractable vertical stabilizer/rudder unit retracted;

FIG. 6B illustrates a front plan view of a high speed aircraft configured with a retractable vertical stabilizer/rudder unit extended;

FIG. 6C illustrates a front plan view of a high speed aircraft configured with a retractable vertical stabilizer/rudder unit retracted;

FIG. 6D illustrates a side plan view of a high speed aircraft configured with a retractable vertical stabilizer/rudder unit extended;

FIG. 6E illustrates a side plan view of a high speed aircraft configured with a retractable vertical stabilizer/rudder unit retracted;

### DETAILED DESCRIPTION OF THE INVENTION

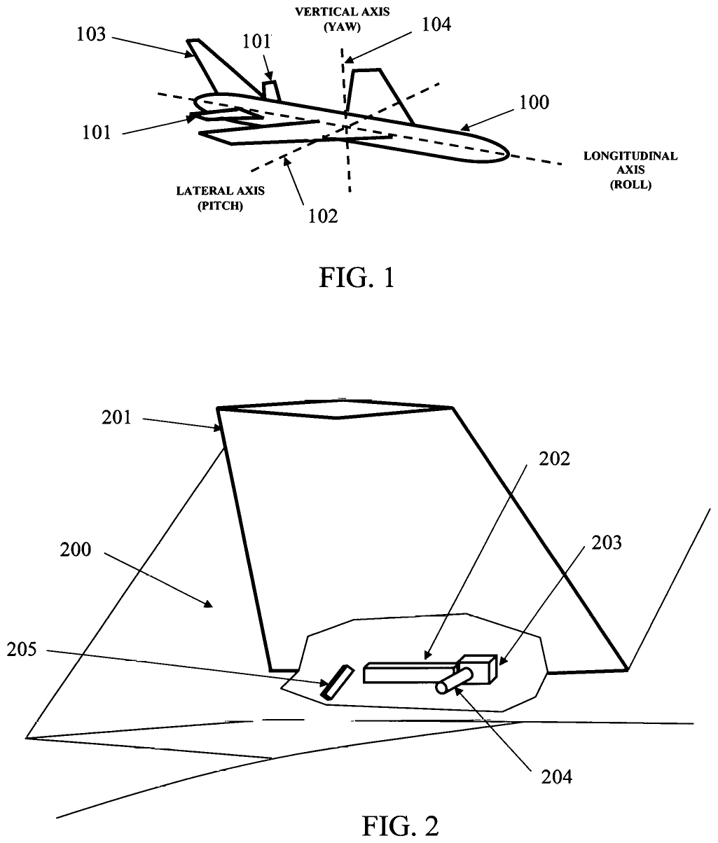

Referring to FIG. 1 the horizontal stabilizers/elevators 101 are used to control the aircraft 100 about the lateral or pitch axis 102, while the vertical stabilizer/rudder 103 is used to control the aircraft about the vertical or yaw axis 104.

FIG. 2 shows the components of a typical stabilizer/rudder assembly 201 installed on a typical aircraft 200. The components include: a pivotal connecting means 202, such as a hinge mechanism; a latching means 203, such as a locking mechanism; and a drive means 204, such as an actuator mechanism. All of said mechanisms are readily available “off the shelf” or easily constructed from available technology. For example, said actuator mechanism 204 could be mechanical, electrical as a conventional electric jackscrew, or hydraulic as a standard hydraulic cylinder. There would also be a rudder control mechanism 205, which is already part of any aircraft rudder assembly, and which allows the pilot to control the rudder by activating the rudder pedals. Said rudder control mechanism 205 should be deactivated when the stabilizer/rudder assembly 201 is in the retracted position.

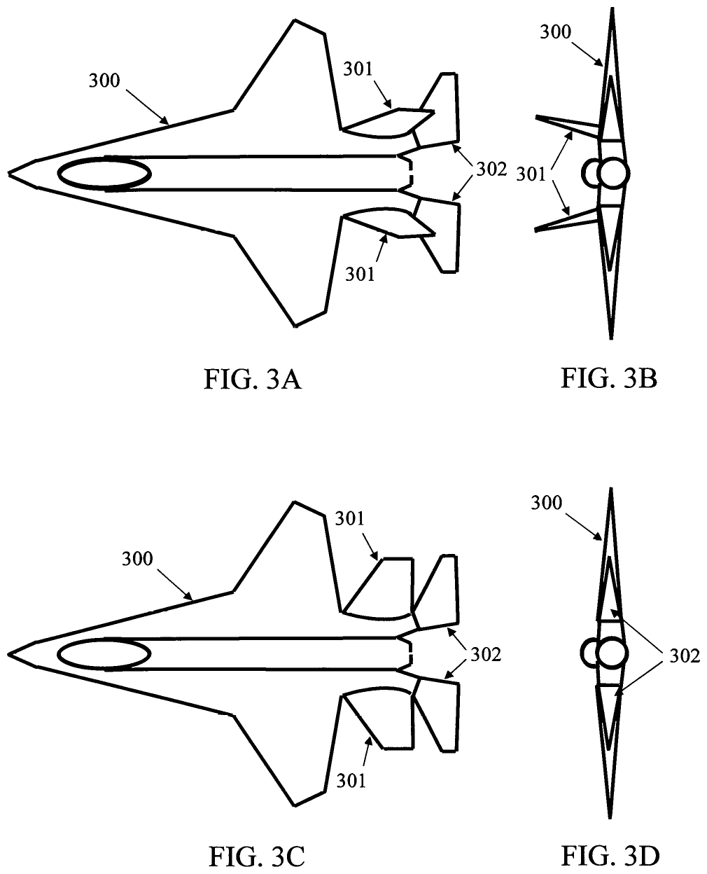

Referring to FIGS. 3A and 3B, vertical stabilizers/rudders 301 and horizontal stabilizers/elevators 302 form the tail section (empennage) of an aircraft 300. Vertical stabilizers/rudders 301 are attached to the aircraft substantially parallel to the longitudinal axis by means of a pivotal connecting mechanism, such as a hinge. In the displayed embodiment vertical stabilizers/rudders 301 are shown extended and are locked into a near vertical position. In this configuration said vertical stabilizers/rudders 301 function the same as any conventional aircraft vertical stabilizers/rudders.

Referring to FIGS. 3C and 3D, vertical stabilizers/rudders 301 are shown retracted to a near horizontal position substantially parallel to the lateral axis of the aircraft 300. In the displayed embodiment said vertical stabilizers/rudders 301 are locked into a near horizontal position, thus reducing drag and increasing stealth characteristics of the aircraft.

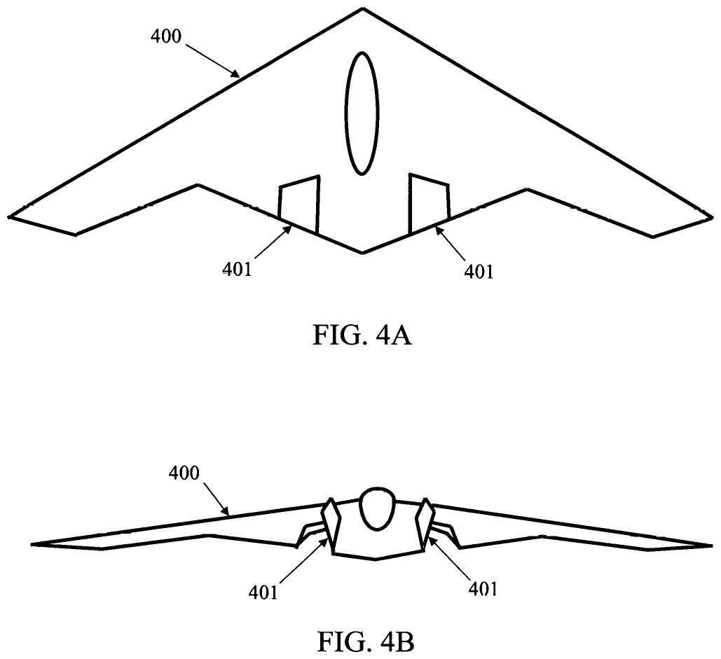

Referring to FIGS. 4A and 4B, vertical stabilizers/rudders 401 are shown as they would function on an all-wing aircraft 400. When retracted as shown in FIG. 4A, the vertical stabilizers/rudders 401 do not interfere with the normal operation of the aircraft nor interfere with its stealth profile. As in the previous embodiment, said vertical stabilizers/rudders 401 are attached to the aircraft approximately parallel to the longitudinal axis of the aircraft by means of a pivotal connecting mechanism, such as a hinge. When extended to a near vertical position by an actuator mechanism and locked into the desired position by a latching mechanism, as shown in FIG. 4B, said vertical stabilizers/rudders 401 function the same as any conventional aircraft's vertical stabilizers/rudders, thus greatly increasing the pilot's ability to control the aircraft about the vertical or yaw axis.

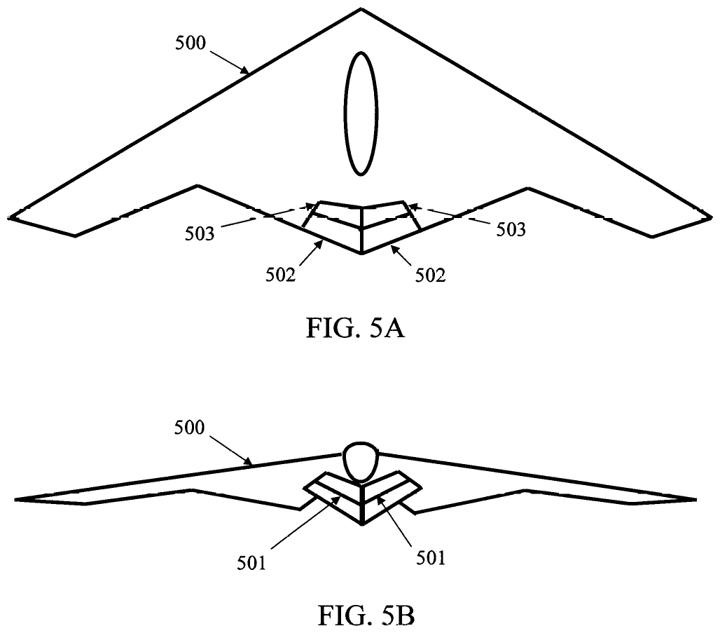

FIGS. 5A and 5B, show an embodiment wherein the disclosure includes a combination rudder and elevator assembly 501, known as a “ruddervator”, which functions as both vertical stabilizers/rudders and horizontal stabilizers/elevators. By controlling the up and down angle of the rudders/elevators, the pilot can control both the pitch and the yaw of the aircraft. The displayed embodiment shows the rudder/elevator panels 502 separate from and hinged to the stabilizer panels 503; however, a combination stabilizer/rudder/elevator assembly would function in a similar manner.

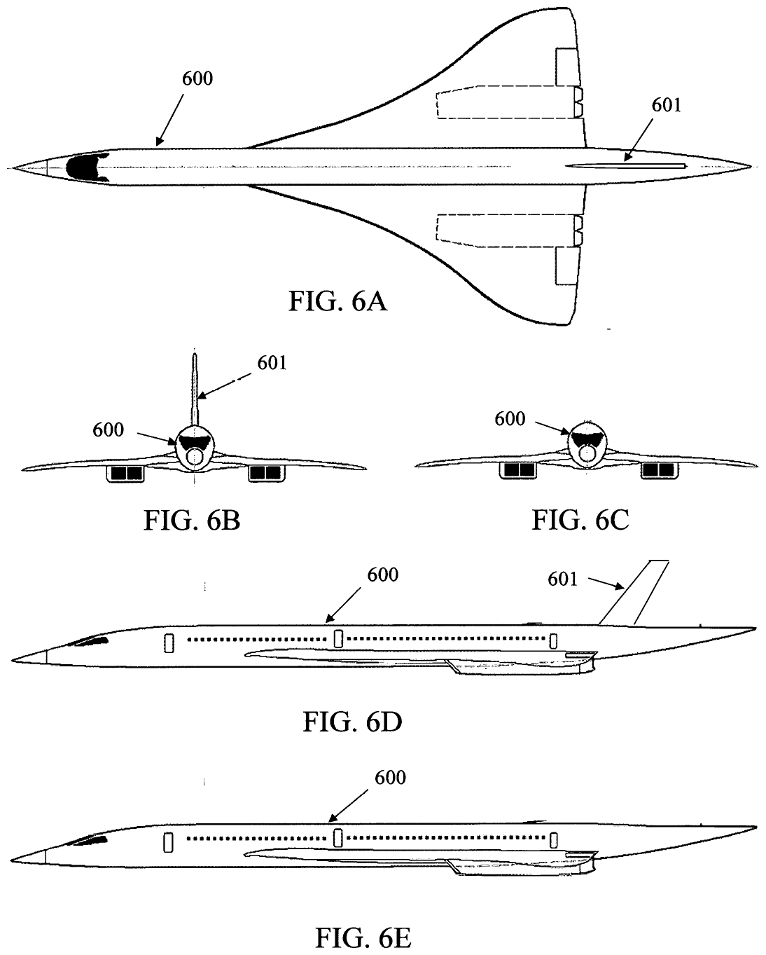

FIGS. 6A through 6E show a large high speed passenger aircraft 600 wherein the disclosure includes a single retractable stabilizer/rudder assembly 601. FIGS. 6B and 6D show the aircraft 600 with the stabilizer/rudder assembly 601 extended for greater yaw control. FIGS. 6C and 6E show the aircraft 600 with the stabilizer/rudder assembly retracted for greater speed. Said stabilizer/rudder assembly 601 is attached to the aircraft by means of a pivotal connecting mechanism, such as a hinge, approximately parallel to the lateral axis of the aircraft.

The embodiments displayed in the accompanying figures show the disclosure as it would generally be designed and manufactured, with an extended profile above horizontal. However, the disclosure also includes configuring the stabilizer/rudder assembly to operate at any angle relative to the horizontal. The apparatus could be hinged about a horizontal axis extending in parallel to either the longitudinal axis of the aircraft (as in FIGS. 3A through 5B) or to the lateral axis of the aircraft (as in FIGS. 6A through 6E). The apparatus could be retracted out of the slipstream but external to the airframe (as in FIGS. 3C and 3D); retracted to blend in with the airframe of the aircraft (as in FIGS. 4A and 5A); or retracted into the airframe of the aircraft (as in FIGS. 6C, and 6E). The apparatus could be separate from the horizontal stabilizer/elevator assembly of the aircraft (as in FIGS. 3A through 3D) or combined to form one assembly (as in FIGS. 5A, and 5B). This disclosure illustrates the application of the invention to several types of aircraft, some with single vertical stabilizer/rudder assemblies and some with dual assemblies. Therefore, many designs and in-flight configurations of the invention are possible.

According to the present invention, a retractable vertical stabilizer/rudder assembly is obtained which allows the vertical stabilizer/rudder to be retracted out of the slipstream, reducing drag and increasing stealth, or to be extended into the slipstream, increasing yaw control of an aircraft.

Although the disclosure has been described with reference to specific examples and embodiments, it is to be understood that the invention is intended to cover all modifications and equivalents within the scope of the appended claims.

What is claimed is:

1. A vertical stabilizer and rudder assembly for an aircraft comprising:
a vertical stabilizer/rudder panel wherein the stabilizer and the rudder are constructed as one piece;
a pivotal connecting means which attaches said assembly to said aircraft, and which means lies substantially parallel to the longitudinal axis of said aircraft, such that said assembly can be rotated about a line substantially parallel to said longitudinal axis of said aircraft;
a drive means to control movement of said assembly about a line substantially parallel to said longitudinal axis of said aircraft; and
a latching means to positively lock said assembly into position.

2. The apparatus of claim 1, wherein said pivotal connecting means, which attaches said assembly to said aircraft, lies substantially parallel to the lateral axis of said aircraft, such that said assembly can be rotated about a line substantially parallel to said lateral axis of said aircraft.

3. The apparatus of claim 1, wherein said assembly consists of a separate vertical stabilizer panel and a separate rudder panel wherein the stabilizer section and the rudder section of said assembly are two separate pieces; and further comprising:
a pivotal connecting means which attaches said rudder panel to said vertical stabilizer panel to form said assembly, such that said rudder panel can be moved at an angle relative to said vertical stabilizer panel.

4. The apparatus of claim 2, wherein said assembly consists of a separate vertical stabilizer panel and a separate rudder panel wherein the stabilizer section and the rudder section of said assembly are two separate pieces; and further comprising:
a pivotal connecting means which attaches said rudder panel to said vertical stabilizer panel to form said assembly, such that said rudder panel can be moved at an angle relative to said vertical stabilizer panel.

5. The apparatus of claim 1, wherein said assembly forms a v-tail of said aircraft, functioning as both a vertical stabilizer/rudder and as a horizontal stabilizer/elevator, a ruddervator, thus controlling both yaw and pitch of the aircraft.

6. The apparatus of claim 5, wherein said assembly consists of a separate stabilizer panel and a separate ruddervator panel wherein the stabilizer section and the ruddervator section of said assembly are two separate pieces; and further comprising:
a pivotal connecting means which attaches said ruddervator panel to said stabilizer panel to form said assembly, such that said ruddervator panel can be moved at an angle relative to said stabilizer panel.
